(19) United States
(12) Patent Application Publication
(10) Pub. No.: US 2016/0188840 A1
(43) Pub. Date: Jun. 30, 2016

(54) PROPER DISPENSING OF ITEMS THROUGH PROXIMITY DETECTED DEVICES WITH USERS

(71) Applicant: EBAY INC., San Jose, CA (US)

(72) Inventors: David Edward Eramian, Mountain View, CA (US); Matthew Scott Zises, San Jose, CA (US)

(21) Appl. No.: 14/585,143

(22) Filed: Dec. 29, 2014

(51) Int. Cl. G06F 19/00; G07F 11/00

(52) U.S. Cl. CPC G06F 19/3462; G07F 11/002

(57) ABSTRACT

There are provided systems and methods for proper dispensing of items through proximity detected devices with users. A service provider may set up a wireless beacon next to a dispenser that provides one or more items to a user. The beacons may connect to a user's device and provide the dispenser with identification information for the user. Based on the connection and the identification information, the dispenser may access dispensing information for the user that informs the dispenser of a type, quantity, and amount of one or more items to provide the user. The dispensing instructions may further include time frames for providing the item(s) to the user and other security information required before providing the item(s) to the user. Once the dispensing information is accessed, the dispenser may then provide the user the item(s) in accordance with the dispensing information.

### TECHNICAL FIELD

The present application generally relates to dispensing of items using proximity detected devices and more specifically to utilizing a connection between a device with a user and a beacon on a dispenser to provide items, such as medication, to the user when the user is in proximity to the dispenser.

### BACKGROUND

Certain people may require items dispensed to them through controlled environments. For example, patients may require medications dispensed at certain times and/or in certain dosages. Moreover, other consumers may sign up for prepaid accounts with merchants that dispense items to the consumers through regulated times, intervals, and/or quantities. However, current practices require an administrator to oversee providing these items to the users in order to insure the correct patients, users, consumers, or other parties receive the correct items. Moreover, inexperienced caretakers, such as nurses or doctors may confuse prescriptions between patients, or may incorrectly read the prescriptions and provide incorrect medications or dosages, which can be life-threatening issues. If patients are given the medication themselves, such as by a pharmacist, improper filling of a prescription may leave the patient with incorrect drugs. Additionally, patients given their own medications may self-medicate, which may also create potential life threatening overdoses or less drug efficiency than the ideal or recommended guidelines.

### BRIEF DESCRIPTION OF THE DRAWINGS

FIG. 1 is a block diagram of a networked system suitable for implementing the processes described herein, according to an embodiment;

FIG. 2A is an exemplary environment displaying a dispensing cart providing a user medications based on dispensing instructions, according to an embodiment;

FIG. 2B is an exemplary environment requiring a administrator's presence near a dispensing cart before one or more items is dispensed to a user, according to an embodiment;

FIG. 3 is an exemplary system environment showing dispensing instructions provided to a dispensing cart for use when a user device in proximity to the dispensing cart, according to an embodiment;

FIG. 4 is a flowchart of an exemplary process for proper dispensing of items through proximity detected devices with users, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide proper dispensing of items through proximity detected devices with users. Systems suitable for practicing methods of the present disclosure are also provided.

Various service providers may use short range wireless communication beacons with a device, such as through Bluetooth Low Energy (BLE) communication protocol, LTE Direct communication protocol, WiFi communication protocol, etc. These beacons may communicate with devices to alert users of check-in services through their device. The beacons may provide additional functionality, such as establishing a connection with a device and/or server entity to verify and process transactions. The beacons may provide communications to the devices directly, including information stored in the beacons. The beacons may also provide communication with a device attached to, or in communication with, the beacon, such as a processing, distributing, and/or dispensing machine, mechanism, or device.

A service provider may offer proper dispensing of items through proximity detected devices that a user has with or on their person. The service provider may utilize dispensers that may provide one or more items to the user. The service provider may utilize a short range wireless beacon located on, connected to, or in proximity to the dispenser that communicates with a device of the user. For example, the short range wireless beacon may be physically connected to the dispenser and communicate with a processing unit for the dispenser. The beacon may employ BLE, LTE Direct, WiFi, or other communications that emit a signal receivable by the user's device. The communication may include an identifier for the beacon, the user, the service provider, and/or an administrator of the dispenser that provides one or more items to the user.

A user may set up a user device to passively monitor for BLE, LTE Direct, WiFi, or other communication signals from the beacon. When the user device detects the signal and verifies the identifier(s) from the beacon, both the user device and the beacon may ramp up in power and establish a connection, where the connection may further enable the user device to communicate with the service provider and/or administrator of the dispenser. The beacon may also provide information to the dispenser, such as an identifier for the user received from the user's device. The beacon may be connected to a networked device for the dispenser, or the beacon may include network functionality to communicate with other devices and/or servers. Thus, the beacon enables the user's device to establish a connection, communicate check-in information (e.g., an identifier for the user), and/or initiate a check-in with the dispenser. The check-in may be completed automatically when the user's device is in range of the beacon, or may be completed after prompting the user to check-in when the device is in range of the beacon.

Once the user's device is connected to the wireless beacon for the dispenser, the dispenser may provide one or more items to the user in accordance with dispensing instruction for the user. For example, once the device connects with the wireless beacon, the dispenser may access a database having instructions for dispensing one or more items to a plurality of users. The instructions may include information necessary for the dispenser to determine what item(s) to dispense to the user, a quantity of the item(s) to dispense to the user, and when to dispenser the item(s) to the user. Other parameters may also be established in the instructions, such as a requirement that an administrator, nurse, doctor, and/or caretaker be present at the dispenser in order to administer or provide the item(s) to the user. Thus, the item(s) may correspond to a medication or medications, in various embodiments. In such embodiments, the instructions for dispensing and/or administrating the medication(s) may be established by a physician or other party that may write and provide a prescription to the user. However, other items may also be dispensed to the user, such as food/drinks, money or other credit, etc., where the instructions may be set by the user or based off of requests made by the user. The instructions may be entered to the database by an administrator for the dispenser. In other embodiments, the user or another party may enter the instructions to the database, such as a physician/doctor, nurse, caretaker, etc.

The instructions may be stored in a database of a server entity in communication with the wireless beacon and/or dispenser. In other embodiments, the device or server inputting the instructions may correspond to a processing device and memory for the dispenser or the aforementioned server may provide the instructions for storage by the wireless beacon/dispenser. The instructions may further include information identifying the user or the user's device, such as an identifier for the user/device. Thus, when the wireless beacon and the device connect and the user is identified using the connection, the instructions for the user may be accessed by the dispenser. The dispenser may then provide the item(s) in the instructions to the user based on the instructions. As previously discussed, another party may be required to be present for the dispenser to provide the items to the user. Thus, a device for the other party may connect to the wireless beacon, which may be used to determine that the other party is present at the dispenser. In other embodiments, the other party may provide other information to the dispenser, such as an access code or identification information. Additionally, the user may be required to enter identification information to the dispenser, in various embodiments, to prevent unauthorized access of item(s) to persons who may utilize the user's device with the dispenser without the user present at the dispenser. Additionally, if the user's device disconnects from the wireless beacon, for example, by the user walking away from the dispenser, the dispenser may retract the item(s) to prevent another party from taking the user's item(s).

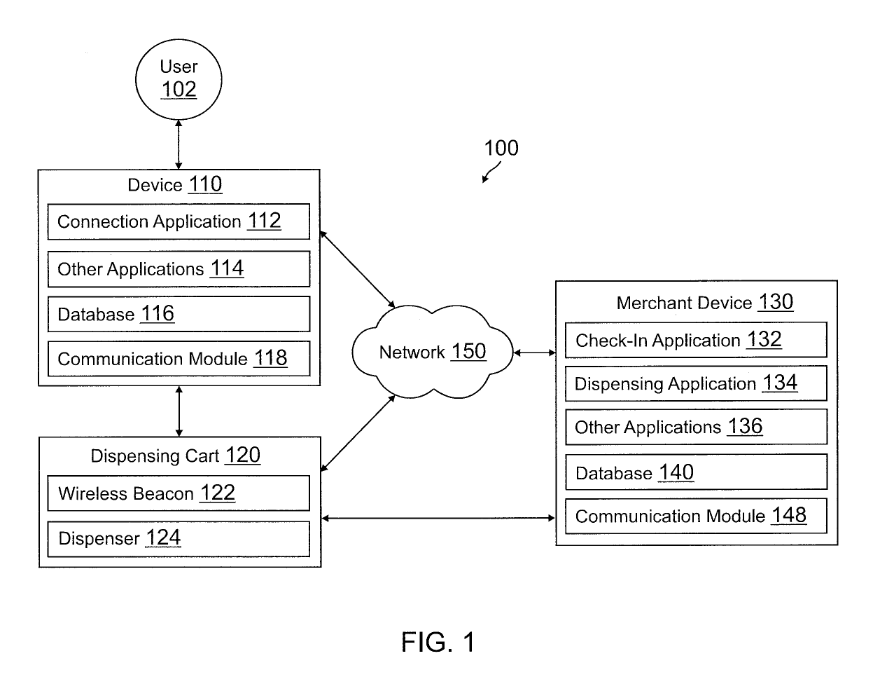

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a device 110, a dispensing cart 120 having a wireless beacon 122 and a dispenser 124, and a managing device 130 in communication over a network 150. User 102, such a patient or consumer, may receive one or more items dispensed by dispensing cart 120. Dispenser 124 may be configured to provide the one or more items when device 110 connects with wireless beacon 122. Additionally, dispenser 124 may receive instructions for dispensing the one or more items to user 102 from managing device 130.

Device 110, wireless beacon 122, dispenser 124, and managing device 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Device 110 may be implemented using any appropriate hardware and software configured for wired and/or wireless communication with wireless beacon 122 and/or managing device 130. For example, in one embodiment, device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. In various embodiments, device 110 may also correspond to a communication device, communicator, or electronic configured to provide identification information, such as check-in information or an identifier, for user 102 to wireless beacons 122. Although a user device is shown, the user device may be managed or controlled by any suitable processing device. Although only one user device is shown, a plurality of user devices may function similarly.

Device 110 of FIG. 1 contains a connection application 112, other applications 114, a database 116, and a communication module 118. Connection application 112 and other applications 114 may correspond to processes, procedures, and/or applications executable by a hardware processor, for example, a software program. In other embodiments, device 110 may include less, additional, or different software as required by the implementation of device 110 (e.g., an RFID tag).

Connection application 112 may be used by user 102 of device 110 to establish a connection with wireless beacon 122 corresponding to dispensing cart 120. Connection application 112 may be configured to connect to wireless beacon 122 in order to enable dispenser 124 to determine dispensing instructions for user 102 and provide one or more items to user 102. In this regard, connection application 112 may receive short range wireless communications from wireless beacon 122 and transmit information to wireless beacon 122, including identification information for user 102 (e.g., an identifier or other token configured to enable dispenser 102 to access dispensing instructions for user 102) and/or check-in information for a check-in process with dispensing cart 120 that associates user 102 with the location corresponding to wireless beacon 122. As will be discussed in more details herein, wireless beacon 122 may be range limited to correspond to a small area nearby or corresponding to dispensing cart 120, thereby insuring only user 102 receives the item(s) provided by dispenser 124.

Connection application 112 may execute in the background of an operating system of device 110 and be configured to establish connections, using communication module 118 of device 110, with wireless beacon 122. The connection may be established with or without user input from user 102. For example, wireless beacon 122 may broadcast a token, such as a universally unique identifier (UUID), for reception by connection application 112, as will be explained in more detail herein. Connection application 112 may utilize communication module 118 of device 110 to receive the token from wireless beacon 122. If connection application 112 acknowledges the UUID as identifying wireless beacon 122, managing device 130, and/or an administrator for dispensing cart 120 (e.g., a physician, doctor, nurse, owner, etc.), connection application 112 may transmit an identifier corresponding to user 102 and/or device 110 back to wireless beacon 122. Connection application 112 may utilize communication module 118 of device 110 to communicate with one or more of wireless beacon 122 (e.g., over near field communication, Bluetooth, Bluetooth Low Energy, radio, infrared, LTE Direct, or other connection). The identifier from device 110 may include, be transmitted with, concatenated with, or otherwise bundled with the identifier received from wireless beacon 122. In other embodiments, different information may be transmitted to wireless beacon 122, such a name or other personal information for user 102, a prescription or prescription identifier for user 102, an identifier for a caretaker, doctor, nurse, etc., for user 102, or other information. Thus, the information transmitted to wireless beacon 122 does not need to be utilized to process and/or complete a check-in with managing device 130 in all embodiments.

However, in other embodiments, connection application 112 may further correspond to an application utilized by device 110 with wireless beacon 122 to complete a check-in for dispensing cart 120 corresponding to wireless beacon 122. The check-in with dispensing cart 120 may correspond to a process to log in to a user account of user 102 with managing device 130 and/or an administrator of dispensing cart 120. The check-in process may then associate user 102 with dispensing cart 120 and/or wireless beacon 122 used to connect to device 110. In other embodiments, the check-in may provide and/or verify the identity of user 102, including transmission of an identifier for user 102 and/or device 110. Thus, managing device 130 and/or the administrator of dispensing cart 120 may be informed that user 102 is in proximity to dispensing cart 120. As previously discussed, in other embodiments, a check-in need not be processed and/or completed to associate user 102 with the dispensing cart 120. Thus, other connections and data transfers to wireless beacon 122 may be sufficient to associate user 102 with dispensing cart 120.

Device 110 includes other applications 114 as may be desired in particular embodiments to provide features to device 110. For example, other applications 114 may include security applications for implementing client-side security features, programmatic client applications for interfacing with appropriate application programming interfaces (APIs) over network 150, or other types of applications. Other applications 114 may contain software programs, executable by a processor, including a graphical user interface (GUI) configured to provide an interface to the user.

Other applications 114 may also include email, texting, voice and IM applications that allow a user to send and receive emails, calls, texts, and other notifications through network 150, for example, between device 110 and managing device 130. In various embodiments, other applications 114 may include financial applications, such as banking, online payments, money transfer, or other applications associated with a payment provider, which may provide payment to managing device 130 or another entity for the items and/or services rendered by dispensing cart 120. Other applications 114 may include browser, social networking, and/or mapping applications, which may also be used in conjunction with connection application 112. In various embodiments, other applications 114 may include browser applications or other dedicated applications enabling user 102 to enter information for items provided by dispensing cart 120, such as prescription medications, food/drink items, or other dispensable item. Thus, other applications 114 may include applications to receive the dispensing instructions, verify the authenticity and/or veracity of the dispensing instructions, and/or enter the dispensing instructions to dispensing cart 120 and/or managing device 130.

In various embodiments, one or more features of connection application 112 and/or other applications 114 may be incorporated in the same application so as to provide their respective features in one application.

Device 110 may further include database 116 which may include, for example, identifiers such as operating system registry entries, cookies associated with connection application 112, payment wallet application 112, and/or other applications 114, identifiers associated with hardware of device 110, or other appropriate identifiers, such as identifiers used for payment/user/device authentication or identification. Identifiers in database 116 may be used by a payment/credit provider, such as payment provider server 170, to associate device 110 with a particular account maintained by the payment/credit provider. Database 116 may include user device tokens and/or encryption keys, including an encryption key of wireless beacon 122, managing device 130, and/or an administrator of dispensing cart 120. Database 116 may include identifying information for tokens enabling connection application 112 to identify wireless beacon 122, managing device 130, and/or an administrator of dispensing cart 120 when receiving a corresponding check-in token. Database 116 may further include dispensing instructions for user 102 used with dispensing cart 120, including identifiers used by dispenser 124 to determine dispensing instructions, dispensing instructions used by dispenser 124, and/or entered data used to determine dispensing instructions (e.g., an image of a prescription).

Device 110 includes at least one communication module 118 adapted to communicate with wireless beacon 122 and/or managing device 130. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacon 122 using short range communications, such as Bluetooth Low Energy, LTE Direct, radio frequency, infrared, Bluetooth, and near field communications.

Dispensing cart 120 may be implemented as a physical structure, conveyor, carrier, vehicle or other unit, which may or may not be mobile, at a location where user 102 may receive one or more items dispensed by dispensing cart 120. In this regard, dispensing cart 120 may include physical displays informing user 102 of what items are available with dispensing cart 120 and/or identifying dispensing cart 120 to user 102. Moreover, dispensing cart 120 may include the item(s) that may be provided to user 102 in accordance with dispensing instructions for user 102 with dispenser 124 and/or other necessary hardware, software, and mechanisms necessary to provide the item(s) to user 102. Although only one dispensing cart is shown, a plurality of dispensing carts may be utilized.

Dispensing cart 120 of FIG. 1 further includes wireless beacon 122 and dispenser 124. Wireless beacon 122 and dispenser 124 may include hardware and software necessary to execute the processes and functions as described below. In other embodiments, dispensing cart 124 may include displays, mechanisms, hardware, and/or software as required.

Wireless beacon 122 may be maintained, for example, by an administrator of dispensing cart 120 and/or managing device 130. Wireless beacon 122 may be implemented using any appropriate hardware and software configured for wireless communication with device 110. For example, in one embodiment, wireless beacon 122 may be implemented as a dongle device including a hardware processor and a communication module, for example, attached to, connected with, and/or corresponding to dispensing cart 120. Wireless beacon 122 may also be implemented as devices incorporated within a personal computer (PC), a smart phone, laptop computer, and/or other types of computing devices capable of transmitting and/or receiving data, such as an IPAD® from APPLE®. Wireless beacon 122 may also act as a stand-alone device including a processor, communication module, and/or network interface component configured to communicate with device 110 and/or managing device 130. Although wireless beacon 122 is described singly, a plurality of wireless beacons may correspond to dispensing cart 120 and/or a plurality of dispensing carts (e.g., a wireless beacon corresponding to each of the plurality of dispensing carts).

Wireless beacon 122 may be located on, near, or corresponding to dispensing cart 120. As previously discussed, dispensing cart 120 may correspond to some physical structure or vehicle for providing one or more items to user 102. Thus, wireless beacon 122 may be attached to dispensing cart 120, in various embodiments, and connected with dispenser 124, either directly or over a communication channel. Wireless beacon 122 may be limited, either by signal range or physical properties of dispensing cart 120/wireless beacon 124, to connect to device 110 only when device 110 is within a certain distance range of dispensing cart 120. For example, wireless beacons 122 may only connect to device 110 within approximately 3 feet of dispensing cart 120. In other embodiments, a closer distance, such as approximately 4-6 inches, may be the proximity distance so that device 110 is required to be physically presented to wireless beacon 122 attached to dispensing cart 120 (e.g., swiped through an area where wireless beacon 122 may connect with device 110).

Wireless beacon 122 of FIG. 1 contains processes, procedures, and/or applications executable by a hardware processor, for example, a software program, configured to interact with device 110 and/or managing device 130. Thus, regardless of the implementation of wireless beacon 122 as discussed above, wireless beacon 122 may utilize a connection/check-in process and include or be connected to a communication module. In other embodiments, wireless beacon 122 may include additional or different hardware and software as required.

Wireless beacon 122 may include an application for transmitting requests to establish a connection between a device (e.g., device 110) and wireless beacon 122. The requests may be unique to wireless beacon 122, thereby identifying wireless beacon 122. Wireless beacon 122 may utilize short range wireless communications of wireless beacon 122 to transmit the requests to establish a connection, including an identifier such as a Universally Unique Identifier (UUID). If device 110 receives a request to establish the connection with wireless beacon 122 and responds with an identifier for user 102/device 110 (potentially including the UUID and other information necessary to effectuate a check-in for user 102), wireless beacon 122 to ramp up in power and create a connection between device 110 and wireless beacon 122.

Wireless beacon 122 may transmit the request to establish the connection with wireless beacon 122 as a short range wireless communication (e.g. a BLE protocol communication) including a “wake up” process for check-in application 112 of device 110 and/or a token for wireless beacon 122 transmitting the request. In other embodiments, the request and/or connection may utilize near field communication, radio communication, infrared communication, or Bluetooth communication. Additionally, although wireless beacon 122 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to wireless beacon 122 (e.g., device 110 and/or merchant device 150) and establishment of a connection for data transfers. In other embodiments, wireless beacon 122 may correspond to other devices, such as WiFi capable devices, near field communication devices, etc.

The request may be specific to device 110 by including information that is specific to user 102 and/or device 110, such as a name, identifier, or device identifier. The information specific to user 102 may be determined from a user account of user 102 or other information previously provided to dispensing cart 120 and/or managing device 130 (e.g., a prescription, receipt or transaction history of previously purchase items or item dispensing plans, etc.). Thus, in certain embodiments, only device 110 will pick up and authenticate the request. In other embodiments, only device 110 (and other device corresponding to user 102) may pick up the request if wireless beacon 122 is range limited to only transmit the request to devices within a certain proximity to dispensing cart 120. The range limitation of wireless beacon 122 may be fixed to a specific area surrounding or nearby dispensing cart 120, or may be adjusted based on a size of dispensing cart 120, area dispensing cart 120 is located, etc.

After wireless beacon 122 receives an identifier from device 110, wireless beacon 122 may determine user 102 is in proximity to wireless beacon 122 and thus dispensing cart 120. If identifiers are received from other users' devices while device 110 is connected to wireless beacon 122, wireless beacon 122 and/or dispenser 124 may require additional identification information and/or authentication before dispenser 124 provides one or more items to user 102 is accordance with user 102's dispensing instructions. Wireless beacon 122 may pass the identifier (and any other device's identifiers where applicable) to dispenser 124 and/or managing device 130 to associate user 102 (and the other users where applicable) with the wireless beacon 122. By associating user 102 with wireless beacon 122, dispenser 124 and/or managing device 130 may determine user 102 is in proximity to dispensing cart 120 and ready to receive one or more items provided by dispensing cart 124.

Wireless beacon 122 may utilize a communication module to pass the identifier received from device 110 to dispenser 124, which may also pass the identifier to managing device 130. However, in other embodiments, wireless beacon 122 may utilize a network connection of wireless beacon 122 to pass the identifier to managing device 130 directly. Thus, wireless beacon 122 includes a communication module adapted to communicate with device 110, dispenser 124, and/or managing device 130. The communication module may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. The communication module of wireless beacon 122 may also communicate with device 110 and/or managing device 130 using short range communications, such as Bluetooth Low Energy, LTE Direct, WiFi, radio frequency, infrared, Bluetooth, and near field communications.

Dispenser 124 may correspond to mechanical embodiments with corresponding hardware and software configured to access instructions for dispensing one or more items to user 102 using information received from device 110. Thus, after receiving information identifying user 102 when device 110 connects with wireless beacon 122, dispenser 124 may access the dispensing/distributing information for user 102. The information may be stored to a database local to dispenser 124, such as a database included with a processing component for dispenser 124. However, in other embodiments, dispenser 124 may access a remote database to determine the dispensing instructions for user 102, such as a database 140 included with managing device 130. Thus, dispenser 124 may include hardware and software necessary to locally store and access the dispensing instructions or remote retrieve the dispensing instructions using a network connection of dispenser 124 (or through a network connection of wireless beacon 122, in various embodiments).

Once dispensing instructions for user 102 is accessed, dispenser 124 may determine one or more items to dispense to user 102. In addition to the type of item(s) provided to user 102, dispenser 124 may also determine an amount, dosage, or other measurement of the item(s) to provide to user 102. For example, where dispensing cart 120 corresponds to medications at a hospital or other caretaker facility, dispenser 124 may determine a quantity of pills and a dosage amount per pill to provide user 102. In other embodiments where dispensing cart 120 may provide food and/or drinks to user 102, dispenser may determine a number of food items, volume measurement of drink items, etc., to provide user 102. In this respect, dispenser 124 may include mechanical and/or chemical mechanisms for determining the proper measurement(s) of the item(s) to provide to user 102. If user 102 is no longer in proximity to dispenser 124, such as if device 110 disconnects from wireless beacon 122, dispenser 124 may also include mechanisms for retracting the item(s) for user 102. In various embodiments, if dispenser 124 goes offline and/or does not have the proper item to dispense to user 102, an entity (e.g., a hospital device/server, managing device 130, a doctor/nurse/health care professional, etc.) may be alerted that dispenser 124 cannot provide the item(s) to user 102 and/or other users. Thus, the entity may be alerted that another party should provide service as quickly as possible to one or more of user 120 and/or dispensing cart 120 in order to insure that medications or other items are administered at their proper times.

Thus, the dispensing instructions may determine the type, measurements, and/or other information necessary for administration of the item(s) to user 102. For example, additional dispensing instructions for the administration of the item(s) may include a time and/or time interval that user 102 is required to take the item(s). Thus, if user 102 attempts to access the item(s) prior to a scheduled time, dispenser 124 may prevent the release of the items to user 102. In other embodiments, a doctor, nurse, or other caretaker may be required to be present when user 102 receives the items. Thus, the dispensing instructions may direct dispenser 124 to provide the item(s) to user 102 only if the other party is present at or nearby dispensing cart 120. For example, a second authentication factor may be required to the dispensing instructions, which may require the other party to be located nearby the cart, at least within eye (e.g., through a motion detector and/or camera) view of dispenser 124, within signal range of wireless beacon 122, and/or merely detected at the hospital or on the same hospital floor as dispenser 124. Thus, the other party (e.g., the health care provider) may view or have knowledge that user 102 took their required medicine/dosage. In various embodiments, the additional dispensing instructions may also include requirements for wireless beacon 122 and/or another communication module of dispensing cart 120 to communicate a message to the other party (e.g., the doctor, nurse, or other health care professional) that dispenser 124 dispensed the medication to user 102. Thus, the other party may be informed that user 102 received the medication to prevent double or more dosing as well as to insure user 102 is taking their scheduled medication.

Dispenser 124 may determine the location of the other party based on a connection between a device for the other party and wireless beacon 122, or based upon information entered to dispensing cart 120/dispenser 124. For example, the other party may enter an access code and/or identification information to dispenser 124 in order to provide authentication the other party is in proximity to dispensing cart 120 and enable user 102 to receive the item(s) from dispenser 124. Thus, dispenser 124 may include hardware and/or software configured to receive input from one or more parties and process the input, such as alphanumeric codes, magnetic or other card reader input, images, etc. Dispenser 124 may also require such input and/or identification information from user 102 prior to providing the item(s) to user 102. Wireless beacon 122 and/or dispenser 124 may also wait for approval from the other party (e.g., the health care professional), such as through entry to a device of dispensing care 120 and/or through a message communicated to wireless beacon 122 and/or dispenser 124 from a communication device of the other party.

Managing device 130 may be implemented using any appropriate hardware and software configured for wired and/or wireless communication with device 110, wireless beacon 122, and/or dispenser 124. For example, managing device 130 may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a managing device is shown, the managing device may be managed or controlled by any suitable processing device. Although only one managing device is shown, a plurality of managing devices may function similarly. Moreover, in various embodiments, one or more of the applications, processes, and/or features discussed below in reference to managing device 130 may be included in dispenser 124, and vice versa.

Managing device 130 of FIG. 1 contains a check-in application 132, a dispensing application 134, other applications 136, a database 140, and a communication module 138. Check-in application 132, dispensing application 134, and other applications 136 may correspond to processes, procedures, and/or applications executable by a hardware processor, for example, a software program. In other embodiments, managing device 130 may include additional or different software as required.

Check-in application 132 may correspond to processes to complete check-in with device 110 for a location corresponding to dispensing cart 124. Thus, check-in application 132 may correspond to the merchant device side application configured to receive check-in information from wireless beacon 122 and complete the check-in. The check-in request may include log in information for a user account with managing device 130 and/or an administrator for dispensing cart 120 and thus complete the check-in with user 102 by verifying the account information. For example, the check-in information may include an identifier or other account information for a user/payment account of user 102. However, in embodiments where a user account has not been previously established by user 102, check-in application 132 may receive other information identifying user 102, including a user name/identifier, user device identifier, an identifier for an account with another server, or other information. Such information may also be used to identify dispensing instructions for user 102. For example, the check-in information may include an identifier for user 102 that enables managing device 130 to identify a prescription, food/drink item, or other item(s) that dispensing cart 120 may provide user 102. As previously discussed, in certain embodiments a check-in for user 102 with dispensing cart 120 need not be completed to provide one or more items to user 102 from dispenser 124. Thus, in embodiments where dispenser 124 requests dispensing instructions from managing device 130, check-in application 132 may receive an identifier that may be utilized with dispensing application 134 and database 140 to determine dispensing instructions for user 102.

Dispensing application 134 may be configured to accept dispensing instructions from one or more parties, enter the dispensing instructions to a database for storage, provide the dispensing instructions to dispenser 124, and/or update dispensing instructions, including dispensing instructions stored local to dispenser 124 based on changes made to the dispensing instructions. In this regard, a party, such as user 102, a physician, doctor, nurse, caretaker, administrator, merchant, and/or other party, may enter dispensing instructions to dispensing application 134. Dispensing instructions may correspond to instructions to provide one or more items to user 102. As previously discussed, the item(s) may include medications, medical devices, food, drink, merchant goods, or other types of items/services available to be provided to user 102 through dispenser 124. Thus, dispensing instruction may come in the form of prescriptions submitted by user 102 or a physician/caretaker for user 102, a purchasable item lists offered by a merchant providing the purchasable items through dispenser 124, or other input noting a type of the item(s) available from dispenser 124. The dispensing instructions may include further parameters, such as dosages, quantities, amounts, sizes/volumes, and/or other physical or chemical composition of the type of item. Further, the parameters may include other information required before dispensing the items, such as security verifications, access codes, identity checks, and/or other required parties nearby dispensing cart 120 prior to providing the items. As previously discussed, the parameters may include temporal parameters to providing the item(s), such as a time of day and/or time interval.

Once the dispensing instructions are input to dispensing application 134, dispensing application 134 may store the instructions to database 140. Additionally, dispensing application 134 may provide the instructions to dispenser 124. The instructions may be provided to dispenser 124 for storage by dispenser 124, for example, prior to user 102 attempting to receive one or more items from dispenser 124. However, in other embodiments, dispensing instructions may be provided to dispenser 124 based on a request for dispensing instructions by dispenser 124. Such a request may include an identifier or other identification information for user 102.

Dispensing application 134 may also receive updates to dispensing instructions. Such updates may correspond to a change in a prescription, pre-ordered food/drinks, etc. An update may change one or more items to be provided to user 102 and/or may change a quantity, amount, or dosage of the item(s) provided to user 102. Dispensing application 134 may update the dispensing instructions in database 140. Additionally, dispensing application 134 may update any dispensing instructions stored with dispenser 134.

Managing device 130 includes other applications 136 as may be desired in particular embodiments to provide features to managing device 130. For example, other applications 136 may include security applications for implementing client-side security features, programmatic client applications for interfacing with appropriate application programming interfaces (APIs) over network 150, or other types of applications. In various embodiments, other applications 136 may include financial applications, such as banking, online payments, money transfer, or other applications associated with payment provider server 170. Other applications 136 may contain other software programs, executable by a processor, including a graphical user interface (GUI) configured to provide an interface to the user. In various embodiments, other application 136 may include a financial/transaction processing application, which may be configured to process and/or complete a transaction for one or more item provided by dispenser 124. For example, other applications 136 may be configured to receive a payment request for the item(s), process the payment request, and/or utilize a payment provider to complete the payment request.

Managing device 130 may further include database 140 which may include, for example, identifiers such as operating system registry entries, cookies associated with check-in application 132, dispensing application 134, and/or other applications 136, identifiers associated with hardware of managing device 130, or other appropriate identifiers, such as identifiers used for payment/user/device authentication or identification. In one embodiment, identifiers in database 140 may be used by a payment provider to associate managing device 130 with a particular account maintained by payment provider server 170. Database 140 may also store user 102's information, including check-in information, an identifier, etc., for user 102. As previously discussed, database 140 includes dispensing instructions one or more users (e.g., user 102), as well as parameters, updates, and/or other information corresponding to the dispensing instructions.

Managing device 130 includes at least one communication module 138 adapted to communicate with device 110, wireless beacon 122, and/or dispenser 124. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 138 may communicate directly with wireless beacon 122 using short range communications, such as Bluetooth Low Energy, LTE Direct, radio frequency, infrared, Bluetooth, and near field communications.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

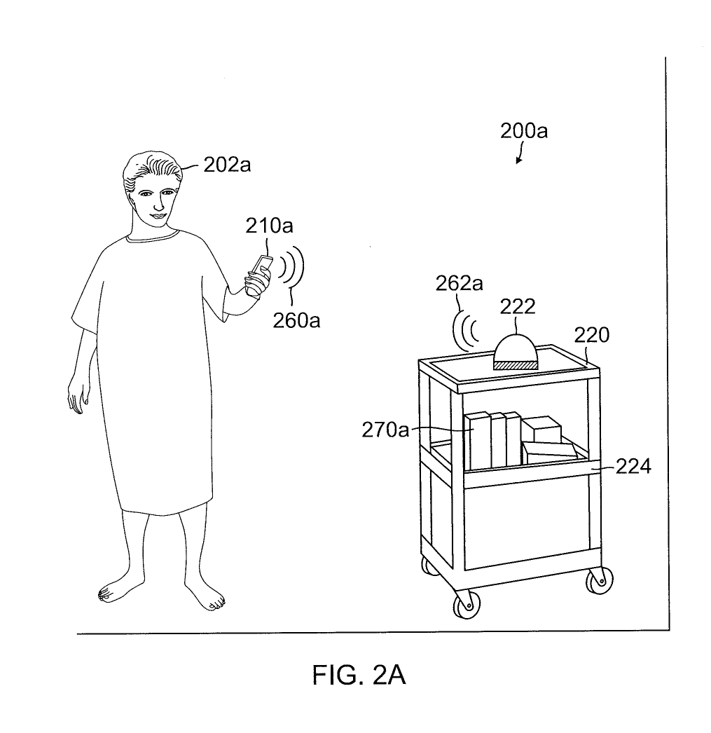

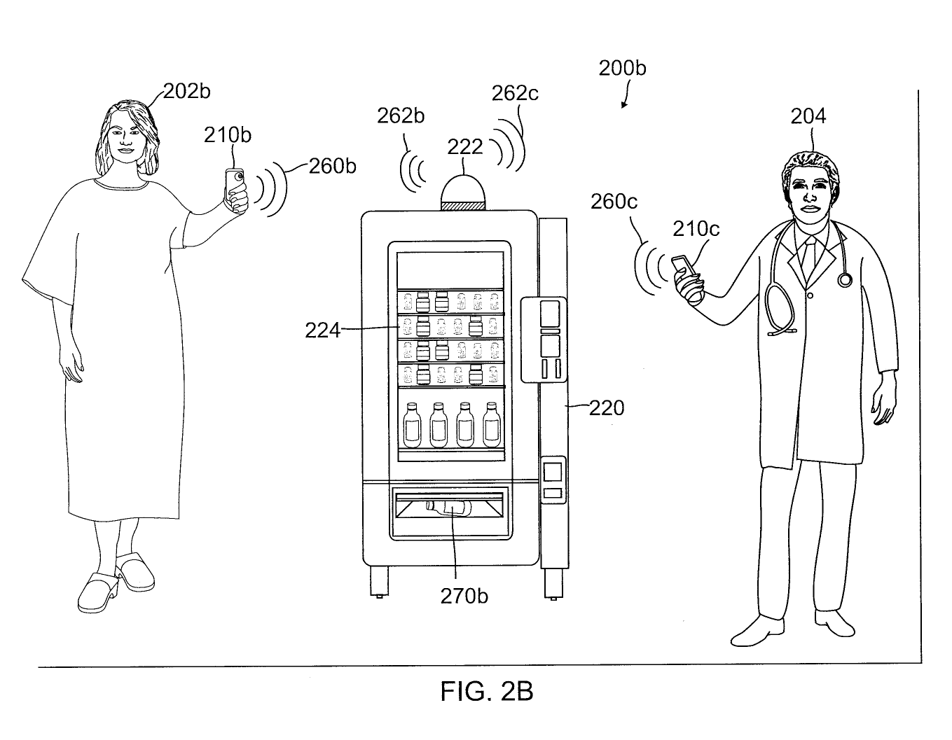

FIG. 2A is an exemplary environment displaying a dispensing cart providing a user medications based on dispensing instructions, according to an embodiment. Environment 200a of FIG. 2A includes a user 202a utilizing a device 210a in proximity to a dispensing cart 220 corresponding generally to user 102, device 110, and dispensing cart 120, respectively, of FIG. 1. Additionally, environment 200a includes a wireless beacon 222 and a dispenser 224 corresponding to wireless beacon 122 and dispenser 124, respectively, of FIG. 1.

As shown in environment 200a, user 202a, such as a patient, brings user device 210a in proximity to dispensing cart 220. Device 210a is shown as a mobile phone in environment 200a; however, in other embodiments device 210a may correspond to a wearable tag, RFID communicator, or other small device that user 202a may include on or nearby their person. When device 210a is in proximity to dispensing cart 220, device 210a and dispensing cart 220 communicate through a signal 260a emitted by device 210a and signal 262a emitted by wireless beacon 222. As previously discussed, wireless beacon 222 may utilize an “always on” or other communication protocol to transmit signal 262a. In other embodiments, device 210a may initiate the communications with wireless beacon 222 through signal 260a. Once a communication channel is established between device 210a and wireless beacon 222, wireless beacon 222 may receive information identifying user 202a and provide the identification information (e.g., an identifier, check-in information, user name, account name, and/or prescription or order identifier) to dispenser 224.

Dispenser 224 is shown as an automated drawer in environment 200a requiring access before a medication 270a is provided to user 202a. Thus, dispenser 224 may only provide access to medication 270a for user 202a if user 202a is authorized to access and receive medication 270a. Dispenser 224 may determine the authorization for user 202a utilizing the information identifying user 202a received from wireless beacon 222. Once dispenser receives the information, dispenser 224 may access dispensing instructions for user 202a and provide access to medication 270a based on the dispensing instructions. Dispenser 224 may also provide the proper dosage, amount, quantity, and/or volume for medication 270a based on the dispensing instructions.

FIG. 2B is an exemplary environment requiring a administrator's presence near a dispensing cart before one or more items is dispensed to a user, according to an embodiment. Environment 200b of FIG. 2B includes a user 202b utilizing a device 210b in proximity to a dispensing cart 220 corresponding generally to user 102, device 110, and dispensing cart 120, respectively, of FIG. 1. In FIG. 2B, dispensing cart 220 appears as a vending machine as another possible embodiment of dispensing cart 220. Additionally, environment 200b includes a wireless beacon 222 and a dispenser 224 corresponding to wireless beacon 122 and dispenser 124, respectively, of FIG. 1.

Environment 200b displays an exemplary environment where an administrator is required to be in proximity to dispensing cart 220 prior to user 202b receiving a medication 270b from dispenser 224. Thus, environment 200b includes an administrator 204, such as a doctor, nurse, physician, or other caretaker, utilizing a device 210c. Similar to environment 200a, in environment 200b, device 210b and wireless beacon communicate using a signal 260b and a signal 262b, respectively. Additionally, device 210c for administrator 204 communicates with wireless beacon 222 using a signal 260c and a signal 262c, respectively. Thus, similar to environment 200a, in environment 200b, when device 210c is in proximity to wireless beacon 222, device 210c either receives signal 262c or emits signal 260c and opens a communication channel with wireless beacon 222.

Therefore, if user 202b is in proximity to wireless beacon 222 with device 210b so that device 210b and wireless beacon 222 are in communication, dispenser 224 may still prevent access and dispensing of medication 270b without administrator 204 being in proximity to dispensing cart 220. However, and as shown in environment 200b, device 210c for administrator 204 is in communication with wireless beacon 222 enabling user 202b to receive medication 270b. Dispenser 224 may provide medication 270b to user 202b in accordance with dispensing instructions accessed by dispenser 224 when wireless beacon 222 is in communication with device 210b and device 210c. Although environment 200b shows administrator 204 utilizing device 210c with wireless beacon 222 to provide authorization for user 202b and access to medication 270b, in other embodiments, administrator 204 may provide other forms of identification and/or authorization, such as providing an access code or identity card to dispenser 224.

Although not shown in FIG. 2B, a second user, such as a second patient may be in proximity to dispensing cart 220. As shown in FIG. 2B, administrator 204 may be able to control the dispensing of medication 270b to user 202b since administrator 204 is in proximity to dispensing cart 220, and therefore prevent medication 270b from being released to the wrong patient (i.e., the second user in proximity to dispensing cart 220). However, in the case of dangerous or addictive medication, dispensing cart 220 may prevent the dispensing of medication 270b where administrator 204 is not present at dispensing cart 220 (e.g., in FIG. 2A where a second user is with user 202a at dispensing cart 220). For example, the second user may be allergic to the medication. Thus, medication 270b may not be released where the risk of contamination or accidental dosage may cause health effects in the second user. In further embodiments, even if administrator 204 is present, medication 270b may be prevented from release to user 202b until the second user is no longer in proximity to dispensing cart 220, thereby preventing unauthorized access or release of medication if user 202b and/or administrator 204 are not aware that medication 270b has been dispensed.

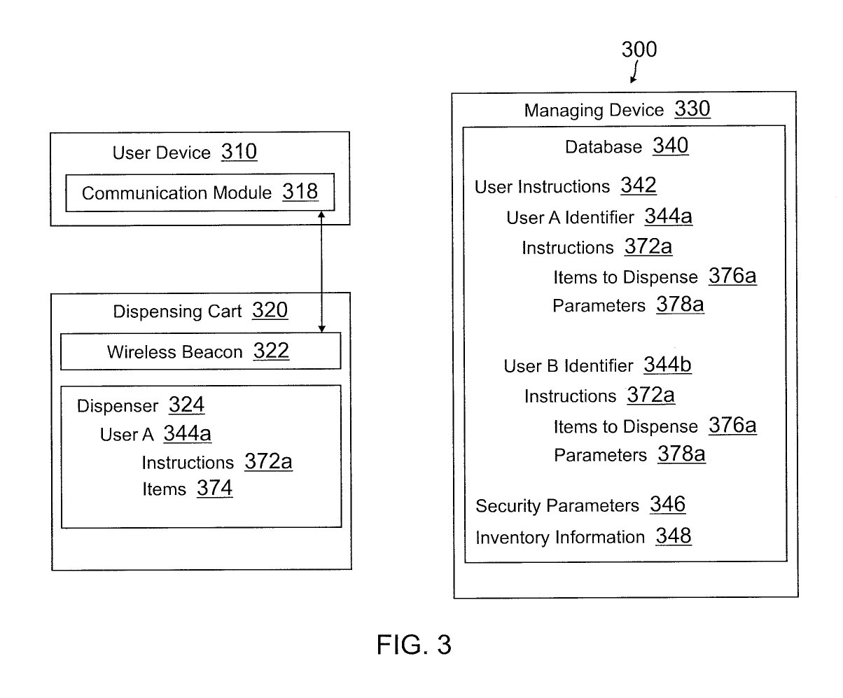

FIG. 3 is an exemplary system environment showing dispensing instructions provided to a dispensing cart for use when a user device in proximity to the dispensing cart, according to an embodiment. Environment 300 includes a device 310, a dispensing cart 320, and a managing device 330 corresponding generally to device 110, dispensing cart 120, and managing device 130, respectively, of FIG. 1. Moreover, environment 300 includes a wireless beacon 322 and a dispenser 324 corresponding generally to wireless beacons 122 and dispenser 124, respectively, of FIG. 1.

Managing device 330 includes a database 340 having data and information described in reference to database 140 of FIG. 1. Database 340 may, therefore, include accessible data used by dispenser 324 to determine dispensing instruction for a user (not shown, but for purposes of FIG. 3, a user A) of device 310. In this respect, device 310 may include a communication module 318 configured to communicate with wireless beacon 322 of dispensing cart 320. As previously discussed, using the communication between device 310 and wireless beacon 322, dispenser 324 may determine that the user A for device 310 is in proximity to dispensing cart 320 and able to receive one or more items from dispenser 324. Thus, after receiving identification information through the communication between device 310 and wireless beacon 322, dispenser 324 may access dispensing instructions for the user A corresponding to device 310.

As shown in environment 300 of FIG. 3, dispenser 324 includes instructions for a user A 344a including instructions 372a and items 374 for user A. Thus, in environment 300, dispenser 324 may locally access the dispensing instructions for user A using identification information received from user device 310, such as user A 344a information. As previously discussed, in other embodiments, dispenser 324 may access the dispensing instruction for user A from database 340. However, in the embodiment of environment 300, managing device 330 has previously transmitted information from database 340 to dispenser 324.

As shown in database 340, information for dispensing instructions is shown as user instructions 342. User instructions 324 include a user A identifier 344a, a user B identifier 344b, security parameters 346, and inventory information 348. User A identifier 344a may correspond to an identifier or other identification information enabling a device, such as dispenser 324 and/or managing device 330 to identify user A when receiving the identifier for user A. User A identifier 344a may be stored with instructions 372a having items to dispense 376a and parameters 378a. Instructions 372a may correspond to dispensing instruction, such as what type, quantity, amount, and/or dosage of one or more items to dispense to user A. Moreover, parameters 378a may include additional parameters for dispensing the item(s) to user A, such as security requirements, presence of other parties, time intervals to dispense the item(s), length of administration or validity of dispensing instructions, etc. Similarly, user B identifier 344b includes instructions 372b having items to dispenser 376b and parameters 378b, corresponding to similar information for a user B.

Database 340 may further include security parameters 346 having general security information for dispensing cart 320. General security information may include access codes required to utilize dispensing cart 320 and/or dispenser 324, location and/or oversight information for dispensing cart 320, or other security information related to the use and administration of dispensing cart 320. Database 340 may further store inventory information 348 related to items 374 and/or other items stored by dispensing cart 320 for administration to one or more users. Inventory information 348 may be utilized to determine a time to refill and/or replace the item(s) available from dispensing cart 320.

After providing user instructions 342 to dispenser 324, dispenser 324 may access dispensing instruction for user A for user device 310. Thus, as shown in environment 300, dispenser 324 has received identification information for user A 344a and accessed instructions 372a for user A. Moreover, dispenser 324 has retrieved items 374 for instructions 372a and may provide items 374 to user A based on instructions 372a.

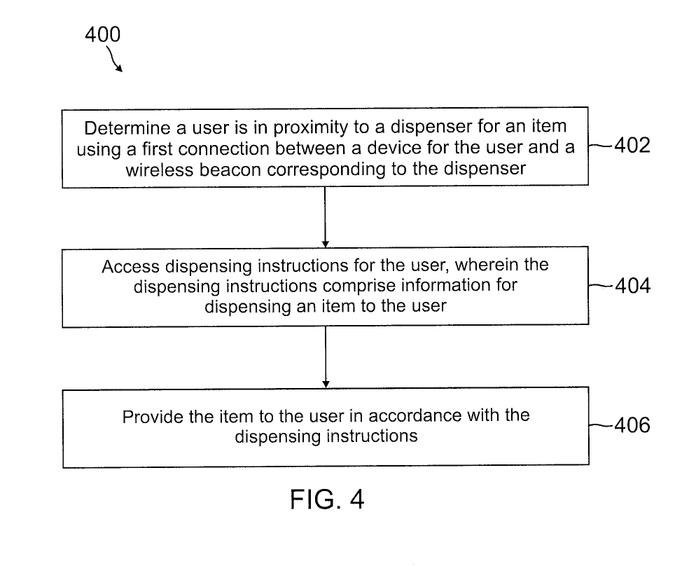

FIG. 4 is a flowchart of an exemplary process for proper dispensing of items through proximity detected devices with users, according to an embodiment. Note that one or more steps, processes, and methods described herein may be omitted, performed in a different sequence, or combined as desired or appropriate.

At step 402, a user is determined to be in proximity to a dispenser for an item using a first connection between a device for the user and a wireless beacon corresponding to the dispenser. The connection may use one of near field communication, radio communication, infrared communication, Bluetooth communication, Bluetooth Low Energy (BLE) communication, LTE Direct communication, and WiFi communication. The item may correspond to a medication, such as a medication noted in a prescription, and may include a dose, number, or other quantity of the medication.

Dispensing instructions for the user are accessed, at step 404, wherein the dispensing instructions comprise information for dispensing an item to the user. Where the item is medication, the dispensing instruction may comprise a prescription that includes the dose, how to administer, frequency of administration, warnings, number, or other quantity of the medication for the user. Thus, the dispensing instructions may further comprise an administrator time and a dosage for the medication. In such embodiments, the dosage of the medication may be measured, and it may be determined that the current time matches the administration time prior to providing the user the medication.

The dispensing instruction may further comprise a requirement that the first user is in proximity to the dispenser based on the first connection. In various embodiments, the dispensing instructions may further comprise a requirement that a second user is in proximity to the dispenser. Thus, it may be determined that the second user is in proximity to the dispenser using on a second connection between a second device of the second user and the wireless beacon. The second user may be one of an administrator of the dispenser, a nurse, a doctor, and a caretaker.

At step 406, the item is provided to the user in accordance with the dispensing instructions. In certain embodiments, prior to providing the item to the user, identification information is received from the first user, wherein the first item is provided based on the identification information. Additionally, if the user is no longer in proximity to the dispenser, for example, if the first connection termination, the item may be retracted so it is no longer available to the user. An update may also be received to the dispensing instructions, which may include a different medication or a change to the quantity, dosage, or other amount of the first medication.

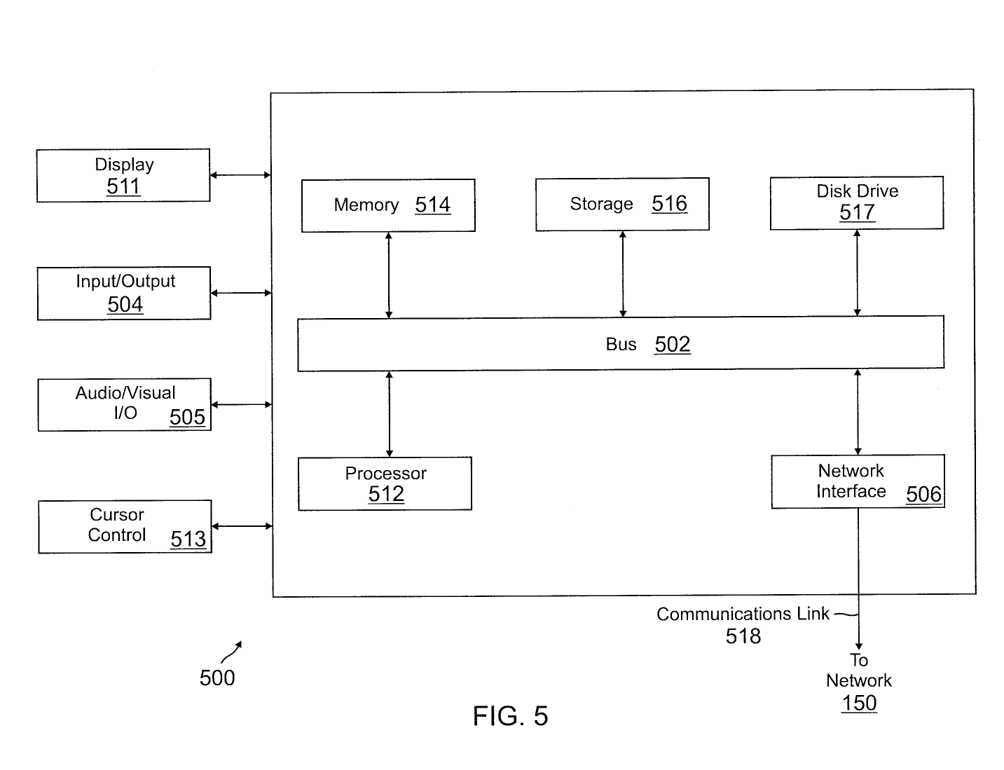

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing dispensing instructions for a plurality of users; and
one or more hardware processors in communication with the non-transitory memory and configured to:
determine a first user of the plurality of users is in proximity to a dispenser for at least one item using a first connection between a first device for the first user and a wireless beacon corresponding to the dispenser;
determine first user specific dispensing instructions for the first user from the dispensing instructions, wherein the first user specific dispensing instructions comprise first information for dispensing the at least one item to the first user; and
cause to be provided the at least one item to the first user in accordance with the first user specific dispensing instructions.

2. The system of claim 1, wherein the first connection uses one of near field communication, radio communication, infrared communication, Bluetooth communication, Bluetooth Low Energy (BLE) communication, LTE Direct communication, and WiFi communication.

3. The system of claim 1, wherein the at least one item comprises medication, and wherein the first user specific dispensing instructions comprise a prescription for the medication.

4. The system of claim 1, wherein the one or more hardware processors are further configured to:
determine a second user of the plurality of users is in proximity to the dispenser using a second connection between a second device for the second user and the wireless beacon;
access second user specific dispensing instructions for the second user from the dispensing instructions, wherein the second user specific dispensing instructions comprise second information for dispensing the at least one item to the second user; and
provide the at least one item to the second user in accordance with the second user specific dispensing instructions.

5. The system of claim 1, wherein the first user dispensing instructions further comprise a requirement that the first user is in proximity to the dispenser based on the first connection.

6. The system of claim 5, further comprising:
causing to be retracted the at least one item when the user is no longer in proximity to the dispenser based on the first connection terminating.

7. The system of claim 1, wherein the first user specific dispensing instructions further comprise a requirement that a second user is in proximity to the dispenser, and wherein prior to the one or more hardware processors providing the at least one item, the one or more hardware processors are further configured to:
determine the second user associated with the first user is in proximity to the dispenser using on a second connection between a second device of the second user and the wireless beacon, wherein the second user comprises one of a nurse, a doctor, and a caretaker for to the user.

8. The system of claim 7, wherein the at least one item comprises at least one of a food item and a drink item, and wherein the first user specific dispensing instructions comprise a preorder of the at least one of the food item and the drink item.

9. A method comprising:
determining a user is in proximity to a dispenser for a first item using a first connection between a first device for the user and a wireless beacon corresponding to the dispenser;
accessing, using one or more hardware processors, dispensing instructions for the user, wherein the dispensing instructions comprise information for dispensing a first item to the user when the user is in proximity to the dispenser; and
providing the first item to the user in accordance with the dispensing instructions.

10. The method of claim 9, wherein the first item comprises a first medication, and wherein the dispensing instructions further comprise an administrator time and a dosage for the first medication.

11. The method of claim 10, wherein prior to providing the item to the user, the method further comprises:
measuring the dosage for the first medication; and
determining that the current time matches the administration time.

12. The method of claim 11 further comprising:
receiving an update to the dispensing instructions.

13. The method of claim 12 further comprising:
providing a second medication to the user in accordance with the update.

14. The method of claim 12, wherein the update comprises an updated administration time and an updated dosage for the medication, and wherein the method further comprises:
providing the first item to the user in accordance with the update.

15. The method of claim 9, wherein prior to providing the item to the user, the method further comprises:
receiving identification information from the first user,
wherein the first item is provided based on the identification information.

16. The method of claim 9, wherein the dispensing instructions further comprise a requirement that an administrator of the dispenser is in proximity to the dispenser, and wherein prior to providing the item, the method further comprises:
determining the administrator is in proximity to the dispenser using on a second connection between a second device of the administrator and the wireless beacon.

17. The method of claim 16, wherein the administrator comprises one of a nurse, a doctor, and a caretaker corresponding to the user.

18. A non-transitory computer-readable medium comprising instructions which, in response to execution by a computer system, cause the computer system to perform a method comprising:
determining a first device for a user is connected to a wireless beacon corresponding to a dispenser;
accessing dispensing instructions for the user, wherein the dispensing instructions comprise information for dispensing a medication to the user; and
providing the medication to the user in accordance with the dispensing instructions.

19. The non-transitory computer-readable medium of claim 18, wherein the dispensing instructions further comprise a requirement that second device for a caretaker for the user is connected to the wireless beacon, and wherein prior to providing the medication, the method further comprises:
determining a second device for the caretaker is connected to the wireless beacon.

20. The non-transitory computer-readable medium of claim 18, wherein the dispensing instructions further comprise an administrator time and a dosage for the first medication.
